(19) United States
(12) Patent Application Publication
(10) Pub. No.: US 2009/0001071 A1
(43) Pub. Date: Jan. 1, 2009

(54) Method and System for Cooling a Bake Plate in a Track Lithography Tool

(75) Inventor: Mayur G. Kulkarni, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD, Kyoto (JP)

(21) Appl. No.: 11/769,902

(22) Filed: Jun. 28, 2007

(51) Int. Cl. H05B 3/68

(52) U.S. Cl. 219/444.1; 219/443.1; 219/448.11; 62/259.2

(57) ABSTRACT

A bake station includes a bake plate having a thickness defined by a distance between an upper surface and a lower surface of the bake plate. The bake plate is configured to heat a substrate positioned adjacent the upper surface of the bake plate. The bake station also includes a base plate having a first surface positioned below and opposing the lower surface of the bake plate and a side plate extending between the lower surface of the bake plate and the first surface of the base plate. The side plate, the lower surface of the bake plate, and the first surface of the base plate define a space. The bake station further includes a plurality of nozzles coupled to the base plate. Each of the plurality of nozzles has an inlet configured to receive an input flow of fluid and an exit port configured to expel an exit flow of fluid onto the lower surface of the bake plate. Additionally, the bake station includes an exhaust port in fluid communication with the space and configured to exhaust the exit flow of fluid from the space.

### BACKGROUND OF THE INVENTION

The present invention relates generally to the field of substrate processing equipment. More particularly, the present invention relates to a method and system for cooling a bake plate of a semiconductor processing tool. Merely by way of example, the method and system of the present invention utilize a cooling fluid to cool a bake plate in a bake chamber of a track lithography tool. The method and system can be applied to other characterization devices for semiconductor processing equipment utilized in other processing chambers.

Modern integrated circuits contain millions of individual elements that are formed by patterning the materials that make up the integrated circuit, such as silicon, metal and/or dielectric layers, to sizes that are small fractions of a micrometer. One of the techniques used throughout the industry for forming such patterns is photolithography. A typical photolithography process sequence generally includes applying a uniform photoresist (resist) layer on the surface of a substrate, drying and curing the layer, patterning the layer by exposing the photoresist to intense light of a particular wavelength that is suitable for modifying the exposed layer, and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various chambers of the track tool, and an interface that allows the tool to be operatively coupled to a lithography exposure tool.

Over the years there has been a strong push within the semiconductor industry to shrink the size of semiconductor devices. The reduced feature size has caused the industry's tolerance of process variability to shrink, which in turn, has resulted in semiconductor manufacturing specifications having more stringent requirements for process uniformity and repeatability. An important factor in minimizing process variability during track lithography processing sequences is to ensure that every substrate processed within the track lithography tool for a particular application has the same “wafer history.” A substrate's wafer history is generally monitored and controlled by process engineers to ensure that all device fabrication processing variables that may later affect a device's performance are controlled, ensuring that all substrates in the same batch are always processed the same way.

To ensure that each substrate has the same wafer history requires that each substrate experience the same repeatable processing steps (e.g., consistent coating process, consistent hard bake process, consistent chill process, etc.) and that the timing between the various processing steps is the same for each substrate. Lithography type device fabrication processes can be especially sensitive to variations in process recipe variables and the timing between recipe steps, which can directly affect process variability and ultimately device performance.

One source of variation that may affect wafer history is the change of process conditions between different process recipes. For example, a particular process recipe in a track lithography tool may require a bake process at a set point temperature of 150° C. Generally, substrates are processed in batches, which may consist of as few as one or as many as 100 or more substrates, and each substrate within a batch is usually processed using the same process recipe. However, substrates in subsequent batches may require a different process recipe, for example, a bake process with a set point temperature of 120° C. In this case the bake plate temperature must be rapidly changed from 150° C. to 120° C. to minimize the time between recipes and the impact on wafer history. Also, minimizing the time between recipes increases throughput and provides efficient utilization of the track lithography tool.

One conventional approach to cooling the bake plate is to turn off the heater power and wait for the bake plate to cool through convective flow. A drawback of this approach is that this cooling process is time-consuming, thereby lowering process chamber throughput. An alternative conventional approach is to place a metal heat-sink in contact with the bake plate. Although this method generally provides more rapid cooling than convective air cooling, this method results in the generation of particles, which may lead to the formation of defects during the semiconductor fabrication process. In view of these requirements, methods and systems for improved cooling of bake plates and other semiconductor process tools are needed.

### SUMMARY OF THE INVENTION

According to the present invention, methods and systems related to the field of substrate processing equipment are provided. More particularly, embodiments of the present invention pertain to a method and system for cooling a bake plate of a semiconductor processing apparatus. While embodiments of the invention may prove to be particularly useful in a heating station of a track lithography tool, other embodiments of the invention can be used in other applications where it is desirable to rapidly cool a plate in a highly controllable manner.

According to one embodiment, a bake station comprising a bake plate is disclosed. The bake plate has a thickness defined by a distance between an upper surface and a lower surface of the bake plate and is configured to heat a substrate supported adjacent the upper surface of the bake plate. The bake station also includes a base plate having a first surface positioned below and opposing the lower surface of the bake plate and an outer peripheral surface extending between the lower surface of the bake plate and the first surface of the base plate. The outer peripheral surface, the lower surface of the bake plate, and the first surface of the base plate define a chamber therebetween. The bake station further includes a nozzle coupled to the base plate, with the nozzle having an inlet configured to receive an input flow of a fluid and a plurality of exit ports configured to expel a plurality of exit flows of fluid onto the lower surface of the bake plate. The bake station further comprises an exhaust port in fluid communication with the chamber and configured to exhaust the fluid from the chamber.

In another embodiment a bake station comprises a bake plate having a thickness defined by a distance between an upper surface and a lower surface of the bake plate. The bake plate is configured to heat a substrate positioned adjacent the upper surface of the bake plate. The bake station also comprises a base plate having a first surface positioned below and opposing the lower surface of the bake plate, and a side plate extending between the lower surface of the bake plate and the first surface of the base plate. The side plate, the lower surface of the bake plate, and the first surface of the base plate define a space. The bake station further comprises a plurality of nozzles coupled to the base plate, each of the plurality of nozzles having an inlet configured to receive an input flow of fluid and an exit port configured to expel an exit flow of fluid onto the lower surface of the bake plate. The bake station further comprises an exhaust port in fluid communication with the space and configured to exhaust the exit flow of fluid from the space.

According to another embodiment, a method of reducing the temperature of a bake plate within a semiconductor processing tool is provided. The method includes establishing a set point temperature and establishing a predetermined tolerance associated with the set point temperature. A fluid is provided to an inlet of a nozzle in fluid communication with the chamber. The fluid flows through a plurality of exit ports disposed on a surface of the nozzle and impinges on the backside surface of the bake plate. The temperature of the bake plate is reduced from a first temperature greater than the set point temperature to a second temperature. The method also includes determining that the temperature of the bake plate is within the predetermined tolerance associated with the set point temperature. The fluid is evacuated through an exhaust port of the chamber, and the flow of the fluid is terminated.

Many benefits are achieved by way of the present invention over conventional techniques. For example, embodiments of the present invention reduce the time utilized to cool a bake plate, thereby increasing process chamber throughput. Additionally, embodiments of the present invention provide for uniform heat removal rates across the surface of the bake plate, thereby reducing the time used to bring the bake plate to a uniform temperature distribution at the new set point temperature. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of one configuration of a track lithography tool;

FIG. 2A is a simplified perspective view of an integrated thermal unit;

FIG. 2B is a simplified perspective view of the integrated thermal unit of FIG. 2A with the top of the unit removed;

FIG. 3 is a simplified perspective view of another integrated thermal unit;

FIG. 4 is a simplified perspective view of a cross-section of one configuration of a bake station;

FIG. 5 is a simplified cross-sectional view of a bake station according to an embodiment of the present invention;

FIG. 6 is a simplified cross-sectional view of a bake station according to another embodiment of present the invention;

FIG. 7 is a simplified plan view of a lower surface of a bake plate according to an embodiment of the present invention; and

FIG. 8 is a simplified flow chart illustrating a method of reducing the temperature of a bake plate within a semiconductor processing tool according to an embodiment of the present invention.

### DETAILED DESCRIPTION OF SPECIFIC EMBODIMENTS

According to the present invention, techniques related to the field of substrate processing equipment are provided. More particularly, the present invention relates to a method and system for cooling a bake plate of a semiconductor processing apparatus. Merely by way of example, the method and system of the present invention utilize a cooling fluid to cool a bake plate in a bake chamber of a track lithography tool. The method and system can be applied to other characterization devices for semiconductor processing equipment utilized in other processing chambers. Embodiments of the present invention are described more fully below with reference to the accompanying drawings, where like numbers refer to like elements throughout.

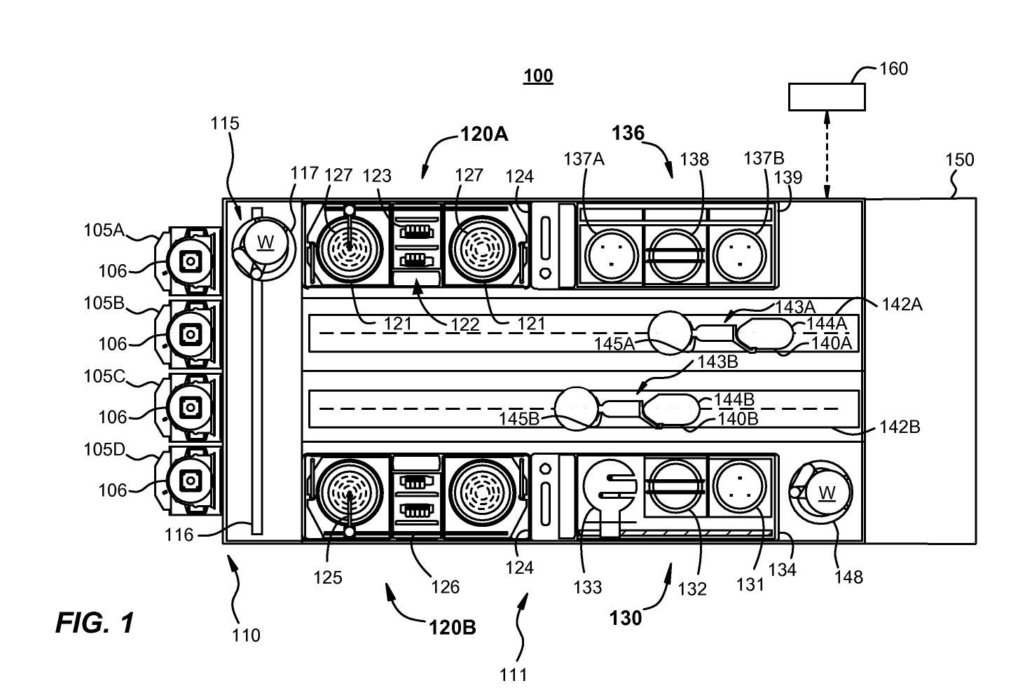

FIG. 1 is a simplified plan view of one configuration of a track lithography tool in which the embodiments of the present invention may be used. As illustrated in FIG. 1, the track lithography tool contains a front end module 110 (sometimes referred to as a factory interface) and a process module 111. In other embodiments, the track lithography tool includes a rear module (not shown), which is sometimes referred to as a scanner interface. Front end module 110 generally contains one or more pod assemblies or FOUPS (e.g., items 105A-D) and a front end robot assembly 115 including a horizontal motion assembly 116 and a front end robot 117. The front end module 110 may also include front end processing racks (not shown). The one or more pod assemblies 105A-D are generally adapted to accept one or more cassettes 106 that may contain one or more substrates or wafers that are to be processed in the track lithography tool. The front end module 110 may also contain one or more pass-through positions (not shown) to link the front end module 110 and the process module 111.

Process module 111 generally contains a number of processing racks 120A, 120B, 130, and 136. As illustrated in FIG. 1, processing racks 120A and 120B each include a coater/developer module with shared dispense 124. A coater/developer module with shared dispense 124 includes two coat bowls 121 positioned on opposing sides of a shared dispense bank 122, which contains a number of dispense nozzles 123 providing processing liquids (e.g., bottom anti-reflection coating (BARC) liquid, resist, developer, and the like) to a wafer mounted on a substrate support 127 located in the coat bowl 121. In the embodiment illustrated in FIG. 1, a nozzle positioning member 125 sliding along a track 126 is able to pick up a dispense nozzle 123 from the shared dispense bank 122 and position the selected dispense nozzle over the wafer for dispense operations. Coat bowls with dedicated dispense banks are provided in alternative embodiments.

Processing rack 130 includes an integrated thermal unit 134 including a bake station 131, a chill plate 132, and a shuttle 133. The bake station 131 and the chill plate 132 are utilized in heat treatment operations including post exposure bake (PEB), post-resist bake, and the like. In some embodiments the shuttle 133, which moves wafers in the x-direction between the bake station 13 land the chill plate 132, is chilled to provide for initial cooling of a wafer after removal from the bake station 131 and prior to placement on the chill plate 132. Moreover, in other embodiments shuttle 133 is adapted to move in the z-direction, enabling the use of bake and chill plates at different z-heights. Processing rack 136 includes an integrated bake and chill unit 139 with two bake station 137A and 137B served by a single chill plate 138.

One or more robot assemblies (robots) 140 are adapted to access the front-end module 110, the various processing modules or chambers retained in the processing racks, and the scanner 150. By transferring substrates between these various components, a desired processing sequence can be performed on the substrates. The two robots 140 illustrated in FIG. 1 are configured in a parallel processing configuration and travel in the x-direction along horizontal motion assembly 142. Utilizing a mast structure (not shown), the robots 140 are also adapted to move orthogonal to the transfer direction. Utilizing one or more of three directional motion capabilities, robots 140 are able to place wafers in and transfer wafers between the various processing chambers retained in the processing racks that are aligned along the transfer direction.

Referring to FIG. 1, the first robot assembly 140A and the second robot assembly 140B are adapted to transfer substrates to the various processing chambers contained in the processing racks 120A, 120B, 130, and 136. In one embodiment, to perform the process of transferring substrates in the track lithography tool, robot assembly 140A and robot assembly 140B are similarly configured and include at least one horizontal motion assembly 142, a vertical motion assembly 144, and a robot hardware assembly 143 supporting a robot blade 145. Robot assemblies 140 are in communication with a controller 160 that controls the system. In the embodiment illustrated in FIG. 1, a rear robot assembly 148 is also provided.

The scanner 150 is a lithographic projection apparatus used, for example, in the manufacture of integrated circuits. The scanner 150 exposes a photosensitive material that was deposited on the substrate in the cluster tool to light to generate a circuit pattern corresponding to an individual layer of the integrated circuit device to be formed on the substrate surface.

Each of the processing racks 120A, 120B, 130, and 136 contain multiple processing modules in a vertically stacked arrangement. That is, each of the processing racks may contain multiple stacked coater/developer modules with shared dispense 124, multiple stacked integrated thermal units 134, multiple stacked integrated bake and chill units 139, or other modules that are adapted to perform the various processing steps required of a track photolithography tool. As examples, coater/developer modules with shared dispense 124 may be used to deposit a bottom antireflective coating (BARC) and/or deposit and/or develop photoresist layers. Integrated thermal units 134 and integrated bake and chill units 139 may perform bake and chill operations associated with hardening BARC and/or photoresist layers after application or exposure.

In one embodiment, controller 160 is used to control all of the components and processes performed in the cluster tool. The controller 160 is generally adapted to communicate with the scanner 150, monitor and control aspects of the processes performed in the cluster tool, and is adapted to control all aspects of the complete substrate processing sequence. The controller 160, which is typically a microprocessor-based controller, is configured to receive inputs from a user and/or various sensors in one of the processing chambers and appropriately control the processing chamber components in accordance with the various inputs and software instructions retained in the controller's memory. The controller 160 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems and the like all well known in the art. A program (or computer instructions) readable by the controller 160 determines which tasks are performable in the processing chambers. Preferably, the program is software readable by the controller 160 and includes instructions to monitor and control the process based on defined rules and input data.

It is to be understood that embodiments of the invention are not limited to use with a track lithography tool such as that depicted in FIG. 1, but may be used in any track lithography tool including the many different tool configurations described in U.S. patent application Ser. Nos. 11/112,281 entitled “Cluster Tool Architecture for Processing a Substrate” filed on Apr. 22, 2005, and 11/315,984 entitled “Cartesian Robot Cluster Tool Architecture” filed on Dec. 22, 2005, both of which are hereby incorporated by reference for all purposes. In addition, embodiments of the invention may be used in other semiconductor processing equipment including CVD chambers, PVD chambers, thermal treatment chambers, and the like.

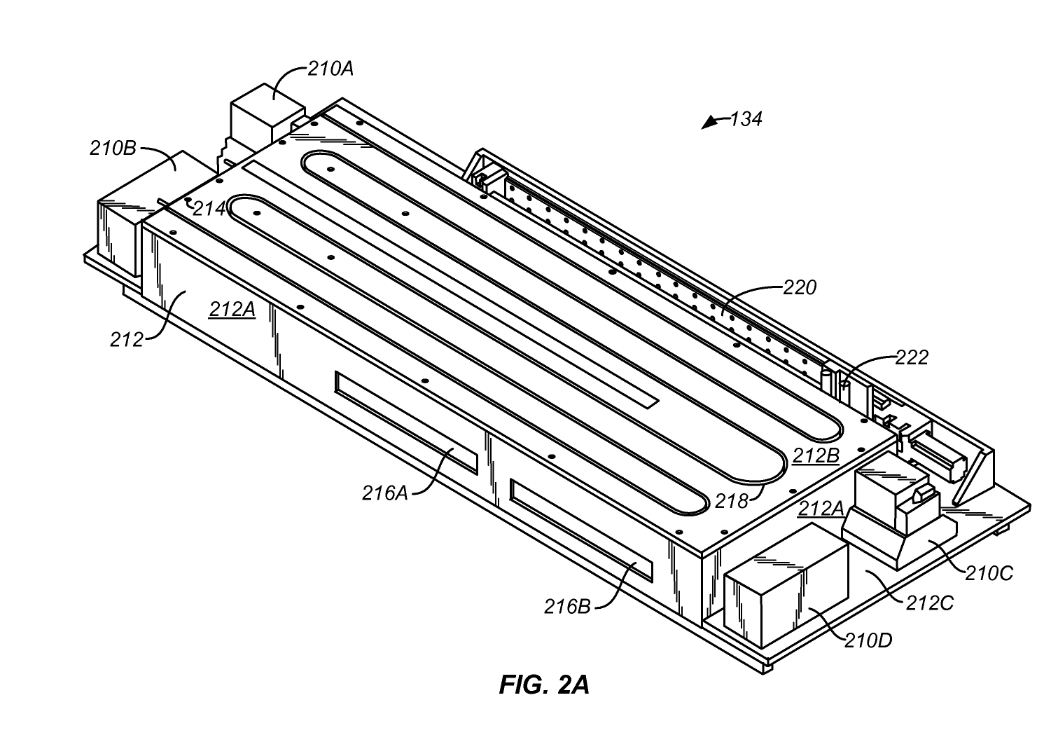

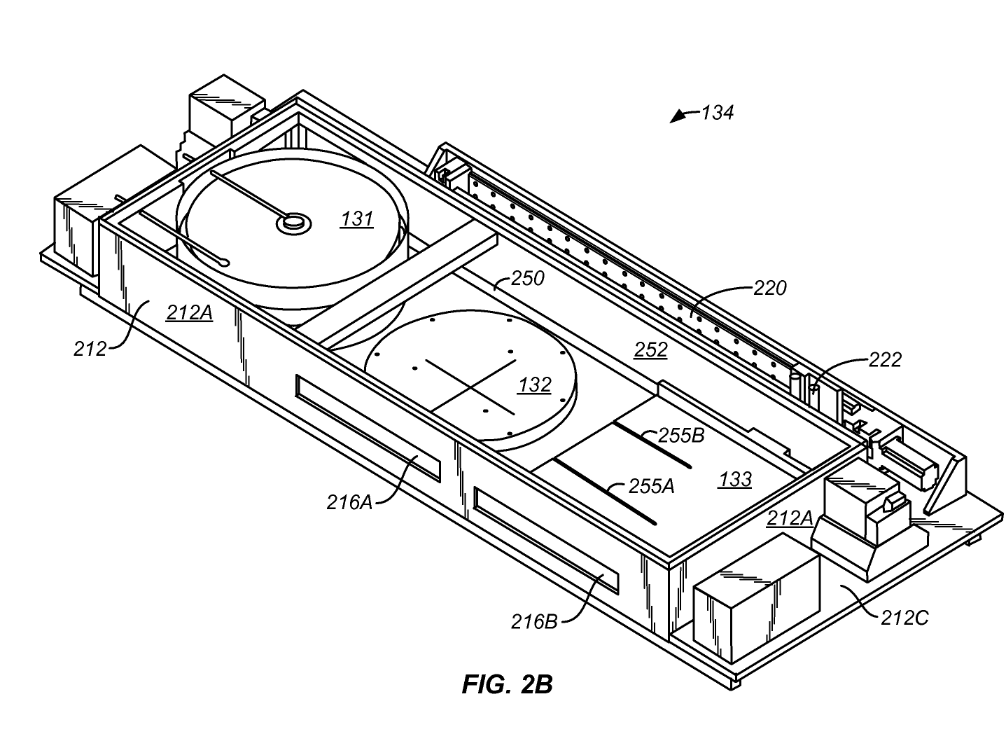

FIG. 2A is a simplified perspective view of an integrated thermal unit. As shown in FIG. 2A, integrated thermal unit 134 includes an exterior housing 212 made of aluminum or another suitable material. Housing 212 is long relative to its height in order to allow bake station 131, chill plate 132, and shuttle 133 to be laterally adjacent to each other and to allow multiple integrated thermal units to be stacked on top of each other in a track lithography tool as described above with respect to FIG. 1.

Housing 212 includes side pieces 212A, a top piece 212B and a bottom piece 212C. Front side piece 212A includes two elongated openings 216A and 216B that allow substrates to be transferred into and out of the thermal unit. Openings 216A and 216B are operatively coupled to be closed and sealed by shutters (not shown). Top piece 212B of housing 212 includes coolant channels 218 that allow a coolant fluid to be circulated through the channels in order to control the temperature of top piece 212B when an appropriate plate (not shown) is attached to top piece 212B via screw holes 214. Similar coolant channels are formed in the lower surface of bottom piece 212C.

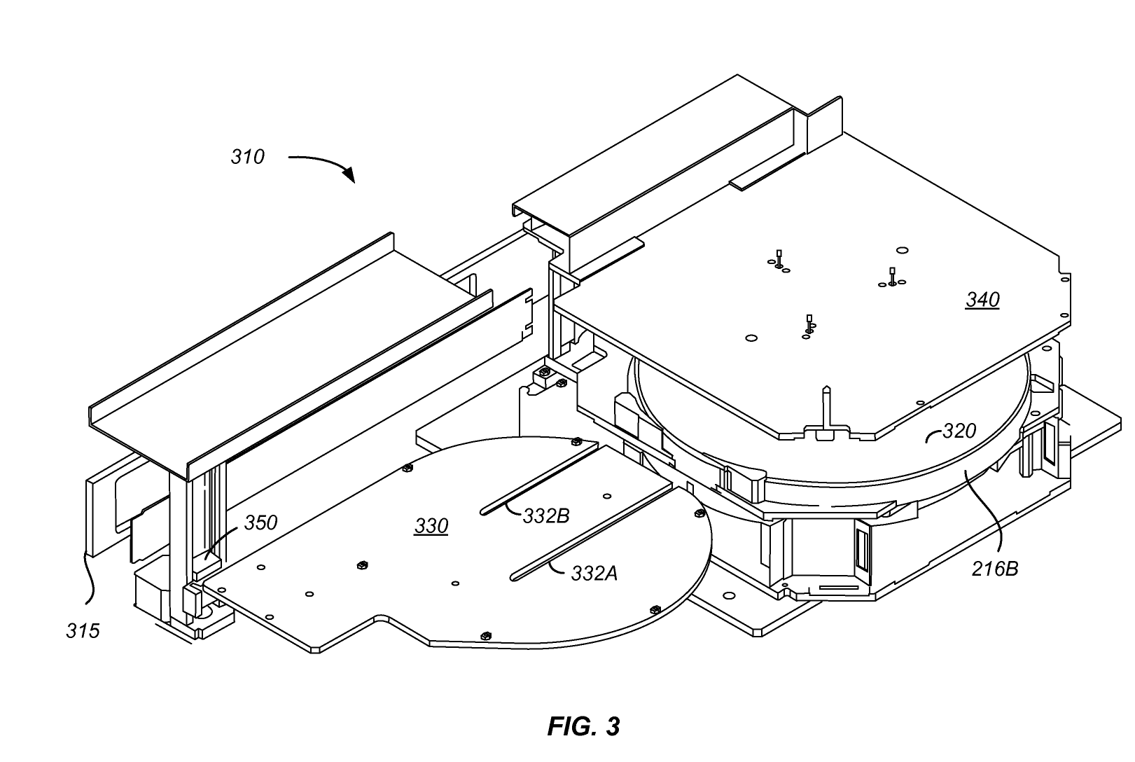

Also shown in FIG. 2A is various control circuitry 210A-210D which controls the precision baking operation of bake station 131 and the precision cooling operation of chill plate 132. FIG. 2A also shows tracks 220 and 222 which enable shuttle 133 (shown in FIG. 3) to move linearly along the length of the thermal unit and vertically within the thermal unit. In one configuration, control circuitry 210A-210D is positioned near bake station 131 and chill plate 132 in order to enable more accurate and responsive control of temperature adjusting mechanisms associated with each station.

FIG. 2B is a simplified perspective view of the integrated thermal unit of FIG. 2A with the top of the unit removed. The integrated thermal unit 134 includes a shuttle 133, a chill plate 132, and a bake station 131 in which substrates are baked during portions of the lithography process. The integrated thermal unit 134 is serviced by a central robot through wafer transfer slots 216A and 216B in surface 212A. Generally, substrates enter the thermal unit through wafer transfer slot 216B and are placed on the shuttle 133. The shuttle delivers the substrate to the chill plate 132 and the bake station 131 as appropriate to the particular thermal processes being performed on the substrate. Lift pin slots 255A and 255B are provided in shuttle 133 to enable lift pins supporting the wafer to pass through the body of the shuttle. Also visible is a space 250 between rear support piece 252 of the housing and a bottom piece 212C. Space 250 extends along much of the length of integrated thermal unit 134 to allow shuttle 133 to transfer wafers between bake and chill plates in the thermal unit.

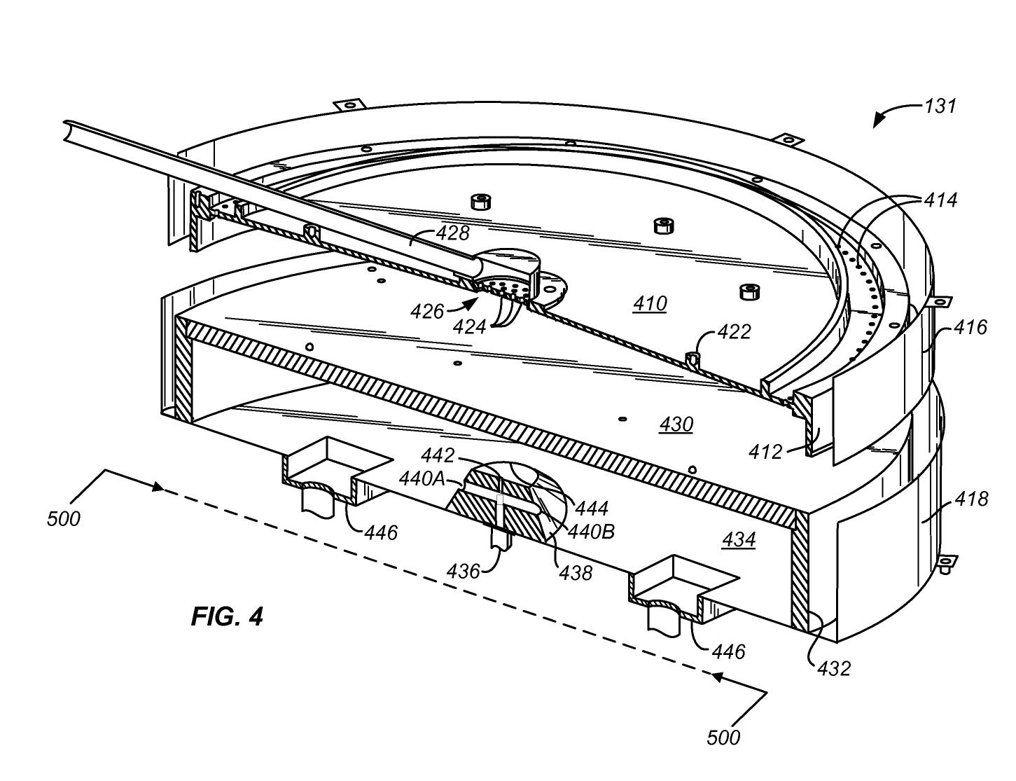

Bake station 131 contains a bake plate 430 (shown in FIG. 4). In some embodiments, the bake plate is a multi-zone heater plate adapted to provide controlled heating to various portions of a substrate mounted on the bake plate. Additionally, some embodiments provide for a single-zone or multi-zone heater lid for the bake station 131. It should be noted that in some embodiments, the lid is not heated as appropriate to the particular application. Additional description of thermal units provided according to embodiments of the present invention is provided in co-pending and commonly assigned U.S. patent application Ser. No. 11/174,988, filed on Jul. 5, 2005 and hereby incorporated by reference in its entirety for all purposes.

FIG. 3 is a simplified perspective view of another integrated thermal unit. Referring to FIG. 3, the integrated thermal unit 310 includes a bake station 320, a transfer shuttle 330, and a chill plate 340. For purposes of clarity, various components of the integrated thermal unit 310, which shares many common components with integrated thermal unit 134 as illustrated in FIGS. 2A and 2B, including control electronics, the exterior housing, motorized lifts, and the like, are not illustrated in FIG. 3.

Although not shown completely in FIG. 3, the integrated thermal unit 310 includes an exterior housing made of aluminum or another suitable material. Portions of the housing are illustrated by panels 315. The exterior housing provides a unit in which the various bake station components are housed in a compact arrangement. The exterior housing also allows multiple integrated thermal units to be stacked on top of each other in a track lithography tool as described above with respect to FIG. 1. The housing includes one or more elongated openings (not shown) similar to the elongated openings 216A and 216B illustrated in FIG. 2A, which allow for substrates to be transferred into and out of the thermal unit. Shutters may be provided to seal the one or more elongated openings.

Transfer shuttle 330 is operable to transfer substrates between the bake station 320, the chill plate 340, and a central robot (not shown). Some embodiments provide for the central robot to access the chill plate 340 directly, enabling loading and unloading of substrates at multiple positions inside the integrated thermal unit. The transfer shuttle is able to move linearly along the length of the thermal unit and vertically within the thermal unit through activation of vertical actuator 350.

Generally, substrates enter the thermal unit by being placed on the transfer shuttle after passing through an elongated opening corresponding to the position of the transfer shuttle 330 as illustrated in FIG. 3. The shuttle delivers the substrate to the chill plate 340 and the bake station 320 as appropriate to the particular thermal processes being performed on the substrate. Lift pin slots 332A and 332B are provided in transfer shuttle 330 to enable lift pins supporting the wafer to pass through the body of the shuttle. The transfer shuttle is mounted on a vertical actuator 350, which enables the transfer shuttle to move vertically within the integrated thermal unit.

Bake station 320 contains a bake plate within a clam shell enclosure as described throughout the present specification. As discussed in relation to FIGS. 2A and 2B, the bake plate may be a multi-zone heater plate adapted to provide controlled heating to various portions of a substrate mounted on the bake plate.

Embodiments of the present invention are utilized in temperature controlled processes performed utilizing bake plates used for post-application-bake (PAB) and/or post-exposure-bake (PEB) processes. Uses are not limited to these processes as the cooling of temperature control structures are included within the scope of embodiments of the present invention. These other temperature control structures include chill plates, develop plates, and the like. One of ordinary skill in the art would recognize many variations, modifications, and alternatives.

FIG. 4 is a simplified perspective view of a cross-section of one configuration of a bake station. Although FIG. 4 illustrates one configuration of a bake station, embodiments of the present invention are not limited to this particular configuration. As illustrated in FIG. 4, bake station 131 includes three separate isothermal heating elements: bake plate 430, top heat plate 410, and side heat plate 412, each of which is manufactured from a material exhibiting high heat conductivity, such as aluminum or other appropriate material. Each plate 430, 410, and 412 may have a heating element, for example resistive heating elements, embedded within the plate. Bake plate 430 is generally fabricated from aluminum and the thickness of the bake plate ranges from about 3-20 mm. In particular embodiments, the thickness of the bake plate ranges from about 5-10 mm, with a preferable thickness of about 5 mm. Bake station 131 also includes side and top heat shields 416 and 418 respectively. In an embodiment, each of heat shields 416 and 418 are made from aluminum. A lid (not shown) is attached to top heat plate 410 by eight screws through threaded holes 422.

Gas is initially introduced into bake station 131 at an annular gas manifold that encircles the outer portion of top heat plate 430. The gas manifold includes numerous small gas inlets 414 (128 inlets in one embodiment). The gas flows radially inward toward the center of the station through a diffusion plate 426 that includes a plurality of gas outlet holes 424. After flowing through diffusion plate 426, the gas exits bake station 131 through gas outlet line 428.

A wafer is positioned adjacent to the upper surface of bake plate 430 and heated according to a particular thermal recipe. One component of the thermal recipe is typically a set point temperature at which the bake plate is set to heat the wafer. During the baking process, the temperature of the wafer is routinely measured and one or more zones of the bake plate can be adjusted to ensure uniform heating of the substrate. Typically, bake plate 430 is heated to the desired set point temperature while a large batch of wafers are processed according to the same thermal recipe. For example, if a particular thermal recipe calls for a set point temperature of 150° C. and that recipe is to be implemented on 100 consecutive wafers, bake plate 430 will be heated to 150° C. during the period of time it takes to process the 100 consecutive wafers. If, however, a subsequent batch of wafers is to be processed according to a different thermal recipe that requires a set point temperature of 120° C., for example, the temperature of bake plate 430 must be rapidly changed from 150° C. to 120° C. between the batches of wafers. Embodiments of the present invention enable a rapid reduction in the temperature of bake plate 430, which helps minimize any delay associated with switching from one thermal recipe to another thermal recipe and thus helps ensure high wafer throughput through integrated thermal unit 134.

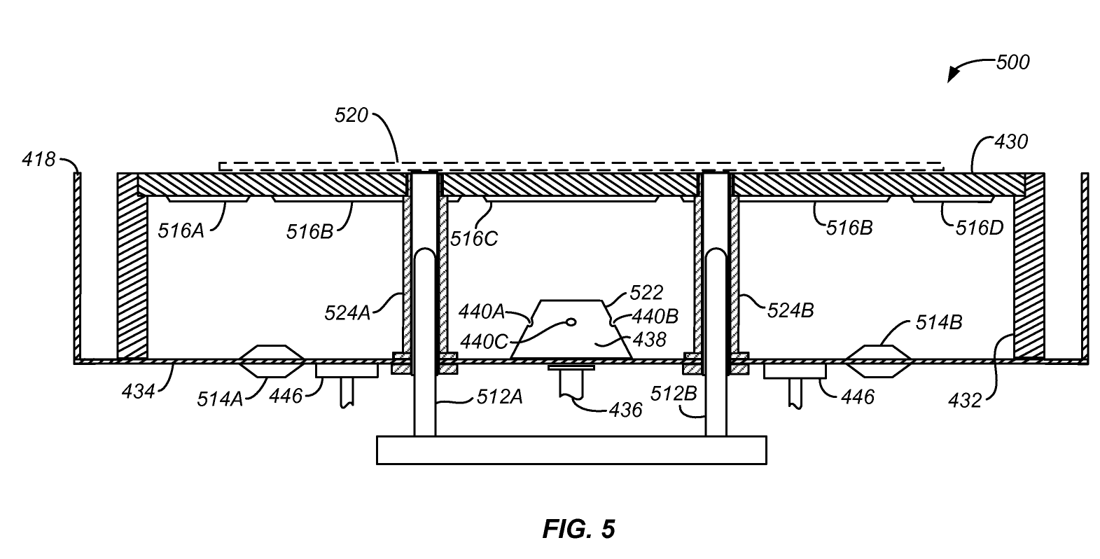

FIG. 4 also shows base plate 434 which has an upper surface positioned below and opposing the lower surface of bake plate 430. Seal 432 (also referred to a side member) extends between the upper surface of base plate 434 and the lower surface of bake plate 430. In some embodiments, seal 432 and base plate 434 may comprise a single plate. The space between the seal 432, the upper surface of base plate 434, and the lower surface of bake plate 430 forms a chamber. The chamber may be sealed to prevent cooling fluid from escaping and causing particle contamination on the upper surface of bake plate 430 or on substrate 520 (shown in FIG. 5).

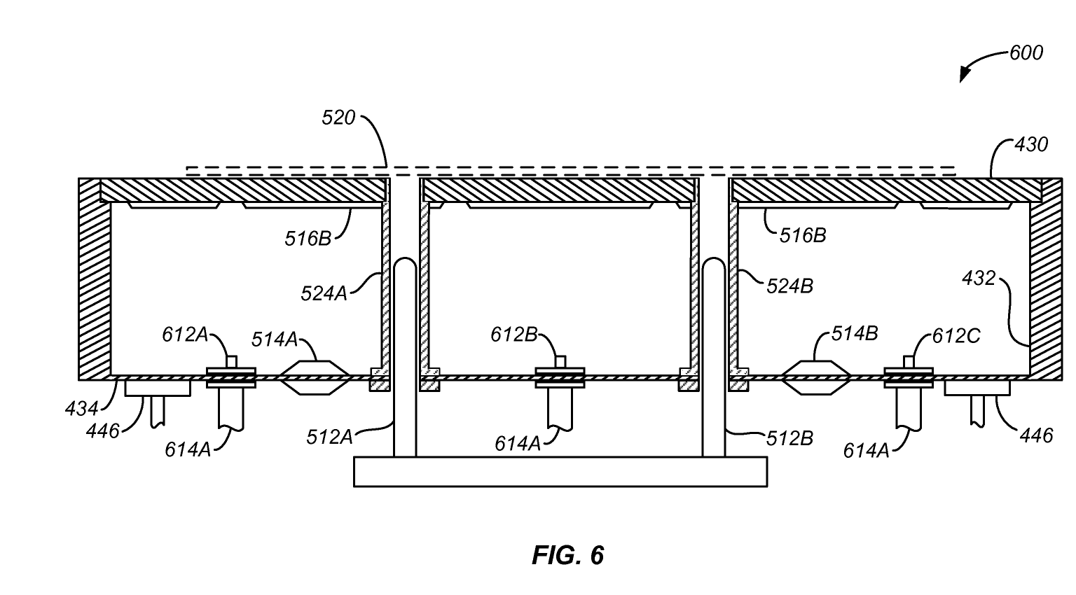

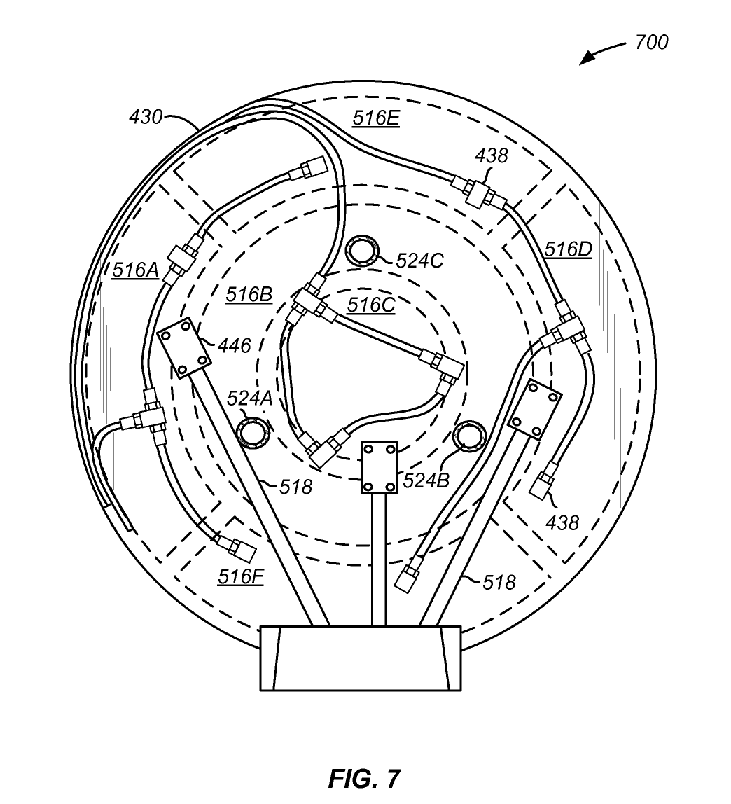

According to an embodiment of the present invention, the temperature of bake plate 430 is rapidly reduced by flowing a cooling fluid through nozzle 438 onto the backside, or lower surface, of bake plate 430. It should be noted that in other embodiments, multiple nozzles are utilized, for example, up to or more than 11 nozzles, as used in the embodiment illustrated in FIGS. 6 and 7. The cooling fluid may comprise air, clean dry air, helium, nitrogen, or any other gas or liquid suitable for reducing the temperature of bake plate 430. The cooling fluid is exhausted from the chamber through one or more exhaust manifolds 446. Exhaust manifolds 446 are connected by one or more exhaust tubes (not shown) to a pump (not shown) which exhausts the cooling fluid from the chamber. Although the two exhaust manifolds 446 illustrated in FIG. 4 are mounted on the bottom portion of the base plate 434, this particular geometry is not required by embodiments of the present invention.

In some embodiments, nozzle 438 has one or more exit ports represented by 440A, 440B, 440C (shown in FIG. 5 only), and 442. The cooling fluid enters nozzle 438 through inlet 436 and is expelled into the chamber through the exit ports. As illustrated in FIG. 4, the diameter of exit ports 440A and 440B on the side surface of nozzle 438 may be different from exit port 442 on the top surface to control the relative flow rates of the cooling fluid expelled from the exit ports. In an embodiment, nozzle 438 has four exit ports on the side surface and one exit port on the top surface. In other embodiments, nozzle 438 may utilize exit ports on the side surface only. As illustrated in FIG. 5, nozzle 438 may have a tapered side surface 522. The tapered side surface 522 directs the flow of cooling fluid expelled from exit ports 440A, 440B, and 440C upward towards the lower surface of bake plate 430. It is to be understood that the configuration of nozzle 438 is not limited to that illustrated in FIGS. 4 and 5 but may be modified in any manner that provides for the cooling fluid to be expelled through exit ports and directed toward the lower surface of bake plate 430. For example, an alternative design may provide for multiple nozzles, each of the nozzles having multiple exit ports. One of ordinary skill in the art would recognize many variations, modifications, and alternatives.

FIG. 5 is a simplified cross-sectional view 500 of a bake station according to an embodiment of the present invention. The cross-section of FIG. 5 is viewed from a perspective slightly off center of bake station 131, represented by dotted line 500 in FIG. 4. As illustrated in FIG. 5, collars 524A and 524B extend between openings in base plate 434 and bake plate 430 and house lift pins 512A and 512B. The lift pins extend through the collars to lift substrate 520 from the upper surface of bake plate 430 during substrate transfer. The points at which the collars 524A and 524B contact base plate 434 and bake plate 430 may be sealed to prevent cooling fluid from escaping from the chamber and causing particle contamination.

FIG. 5 shows grommets 514A and 514B which provide a means for routing wires and/or tubes to and from bake plate 430. For example, the bake plate 430 illustrated in FIG. 7 includes six electrically independent heating element 516A, 516B, 516C, 516D, 516E, and 516F, and each heating element has at least one corresponding temperature sensor (not shown). Depending on the type of temperature sensor used, each sensor and independent heater element requires at least three separate wires and often five or more separate wires (e.g., a five wire arrangement may use two wires for AC power connections to the heater element and three wires for connections to the sensor). Bake plate 430 may also require vacuum and/or gas lines which may be routed through the grommets. In some embodiments, the grommets are sealed to provide an air-tight seal around the wires and/or tubes. However, it is not necessary that the grommets provide an air-tight seal around the wires and/or tubes as long as cooling fluid escaping from the chamber through the grommets is isolated from the upper surface of bake plate 430 and cannot cause particle contamination on substrate 520. The number, size, and configuration of the grommets is variable depending on the design of the bake station 131.

Some embodiments of the present invention utilize two or more exhaust manifolds 446 to exhaust gases from the chamber below the bake plate. Depending on the design of the bake station and the nozzle 438, one or more exhaust tubes (not shown) large enough to provide sufficient exhaust draw from the chamber may be utilized as appropriate to the particular design. Although only two exhaust manifolds are illustrated in FIG. 5, embodiments of the present invention are not limited to this particular design, but may utilize fewer or additional exhaust manifolds as further illustrated in FIG. 7. One of ordinary skill in the art would recognize many variations, modifications, and alternatives.

FIG. 6 is a simplified cross-sectional view 600 of a bake station according to another embodiment of present the invention. The cross-section of FIG. 6 is viewed from a perspective slightly off center of bake station 131, similar to that of FIG. 5. In the embodiment shown in FIG. 6, a plurality of nozzles 612A, 612B, and 612C with corresponding inlets 614A, 614B, and 614C are configured to expel a cooling fluid onto the lower surface of the bake plate 430. In an embodiment, the flow of cooling fluid to each nozzle 612A, 612B, and 612C is controlled independently to provide uniform cooling across the surface of the bake plate 430. Also shown in FIG. 6 are a plurality of exhaust manifolds 446 which are connected to a pump (not shown) by appropriate exhaust tubes. The pump or other exhaust system could be a fab-wide exhaust system. Each exhaust manifold is in fluid communication with the chamber below the bake plate 430 so that after the cooling fluid cools the bake plate, it can be exhausted from the chamber below the bake plate.

The arrangement of nozzles and exhaust manifolds shown in FIG. 6 is not meant to limit the scope of the present invention. Rather, any number of nozzles and/or exhaust manifolds may be used to rapidly cool the temperature of bake plate 430 depending on the material and design of the bake plate and chamber. For example, nozzle 438 shown in FIG. 5 may be utilized with a plurality of exhaust manifolds 446, or the plurality of nozzles 612A, 612B, and 612C shown in FIG. 6 may be utilized with one or more exhaust manifolds as illustrated in FIG. 6. Moreover, the positioning of the exhaust manifolds, which is varied from FIG. 5 to FIG. 6, may be selected to provide efficient flow of the cooling fluid. One of ordinary skill in the art would recognize many variations, modifications, and alternatives within the scope of the present invention.

FIG. 7 is a simplified plan view 700 of a lower surface of a bake plate according to an embodiment of the present invention. The bake plate illustrated in FIG. 7 is merely one of several implementations included within the scope of embodiments of the present invention. FIG. 7 illustrates a bake plate 430 with six electrically independent heating elements 516A, 516B, 516C, 516D, 516E, and 516F. In an embodiment, the flow of cooling fluid is directed to one or more boundaries between adjacent heating elements to provide uniform cooling of bake plate 430. FIG. 7 also illustrates three openings 524A, 524B, and 524C through which lift pins extend during substrate transfer. FIG. 7 illustrates 11 nozzles 438 and associated fluid sources as well as three exhaust manifolds 446 positioned at predetermined positions of the bake plate 430. In the illustrated embodiment, exhaust manifolds 446 are positioned off-center so that a temperature sensor can be positioned at the center of heating zone 516C. As illustrated, exhaust tubes 518 connect to an additional exhaust manifold 710 which is connected to a pump or exhaust system by additional exhaust tubing (not shown).

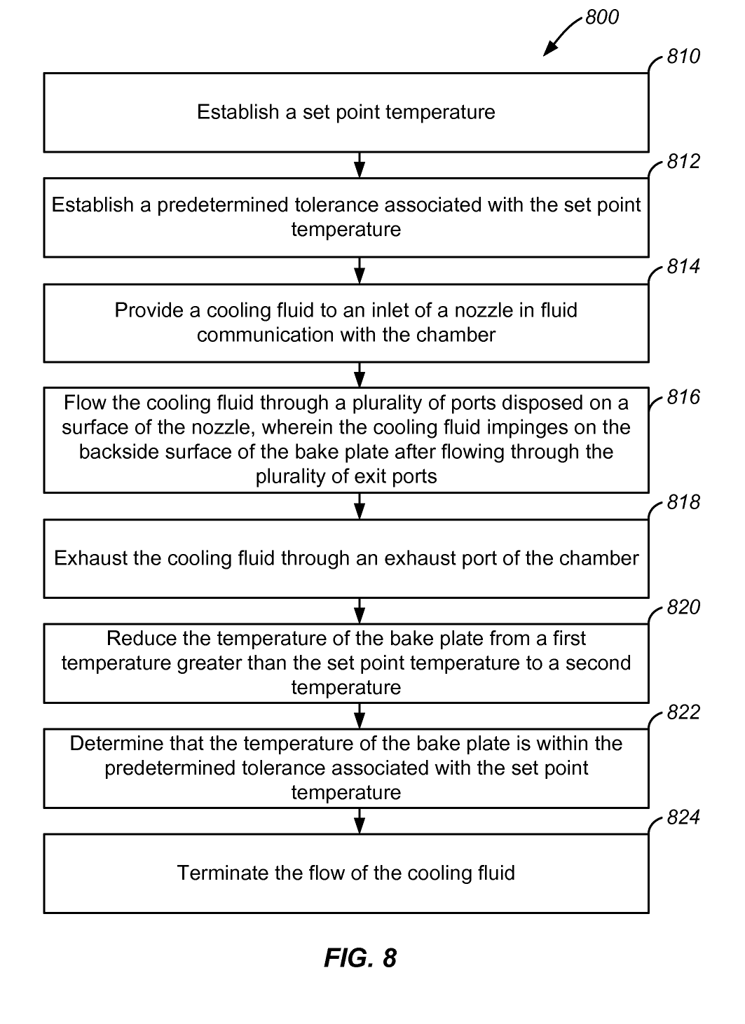

FIG. 8 is a simplified flow chart illustrating a method of reducing the temperature of a bake plate within a semiconductor processing tool according to an embodiment of the present invention. The method 800 includes establishing a set point temperature (810) and establishing a predetermined tolerance associated with the set point temperature (812). The tolerance may be dependent on the temperature of the bake plate or the set point temperature. A fluid is provided to an inlet of a nozzle in fluid communication with the chamber (814). The fluid flows through a plurality of exit ports disposed on a surface of the nozzle and impinges on the backside surface of the bake plate after flowing through the plurality of exit ports (816). The fluid is exhausted through an exhaust port of the chamber (818) as the cooling fluid is provided to the backside surface of the bake plate.

The temperature of the bake plate is reduced from a first temperature greater than the set point temperature to a second temperature (820). The method includes determining that the temperature of the bake plate is within the predetermined tolerance associated with the set point temperature (822). The flow of the fluid is terminated (824) and the exhaust flow may continue or be terminate as well, depending on the particular implementation.

The exhaust flow illustrated by step 818 may be either active or passive. In an embodiment utilizing an active exhaust, negative pressure is provided at exhaust manifolds 446, typically via one or more pumps and/or by connection to a facilities exhaust system. The pressure level of such an active exhaust system may be controlled as appropriate to provide a stable exhaust pressure at the exhaust ports. In an embodiment utilizing a passive exhaust, positive pressure in the chamber below the bake plate 430 is produced by the flow of fluid through the nozzle, thereby resulting in spent fluids passing through the exhaust manifolds after interaction with the bake plate. One of ordinary skill in the art would recognize many variations, modifications, and alternatives.

It should be appreciated that the specific steps illustrated in FIG. 8 provide a particular method of reducing the temperature of a bake plate according to an embodiment of the present invention. Other sequences of steps may also be performed according to alternative embodiments. For example, alternative embodiments of the present invention may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize many variations, modifications, and alternatives.

Based on the description of the present invention herein, a person of skill in the art will appreciate that embodiments of the invention may be beneficially used to cool a bake plate. A skilled artisan will also appreciate that some of the various bake and cool sequence sets just described have differing bake and or cool requirements. Thus, the skilled artisan will appreciate that the functional specifications of a particular bake plate and chill plate incorporated into an integrated thermal unit will depend on the material that the bake plate and chill plate are intended to heat and cool. For example, BARC materials may be adequately heated with a low temperature, low precision bake plate (e.g., a maximum 250° C., single zone heater) while photoresist materials may require a high temperature, mid-precision bake plate (e.g., a maximum 350° C., three zone heater) and the post exposure bake process may require a low temperature, high precision bake plate (e.g., a maximum 250° C., multiple zone heater). Thus, embodiments of the invention are not limited to use with any particular type or configuration of bake plate or chill plate. Instead, generally each bake plate and chill plate is designed to particular performance standards as required by the application for which the bake plate and chill plate will be used as can be determined by a person of skill in the art.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. A bake station comprising:
a bake plate having a thickness defined by a distance between an upper surface and a lower surface of the bake plate, the bake plate being configured to heat a substrate supported adjacent the upper surface of the bake plate;
a base plate having a first surface positioned below and opposing the lower surface of the bake plate;
an outer peripheral surface extending between the lower surface of the bake plate and the first surface of the base plate, wherein the outer peripheral surface, the lower surface of the bake plate, and the first surface of the base plate define a chamber therebetween;
a nozzle coupled to the base plate, the nozzle having an inlet configured to receive an input flow of a fluid and a plurality of exit ports configured to expel a plurality of exit flows of fluid onto the lower surface of the bake plate; and
an exhaust port in fluid communication with the chamber and configured to exhaust the plurality of exit flows of fluid from the chamber.

2. The bake station of claim 1 further comprising:
a first set of openings extending through the bake plate; and
a first set of openings extending through the base plate, wherein each opening in the bake plate is associated with an opening in the base plate.

3. The bake station of claim 2 further comprising:
a first set of collars, wherein each collar extends between an opening in the bake plate and the associated opening in the base plate; and
a first set of lift pins, wherein each lift pin is configured to extend through a collar to lift the substrate from the upper surface of the bake plate.

4. The bake station of claim 3 wherein each collar forms a seal with the bake plate and the base plate.

5. The bake station of claim 1 wherein the bake plate forms a seal with the outer peripheral surface.

6. The bake station of claim 1 wherein the nozzle is characterized by a top surface, a side surface, and a bottom surface, at least one of the plurality of exit ports being positioned on the side surface, the side surface tapering outward from the top surface to the bottom surface.

7. The bake station of claim 1 wherein the bake plate comprises a plurality of heating elements, and wherein the plurality of exit flows of fluid are directed to one or more boundaries between adjacent heating elements.

8. The bake station of claim 1 wherein the exhaust port is laterally positioned off-center of the bake plate.

9. The bake station of claim 8 further comprising a second exhaust port.

10. The bake station of claim 9 further comprising a third exhaust port.

11. The bake station of claim 1 wherein the fluid comprises at least one of nitrogen, helium, air, or clean dry air.

12. The bake station of claim 1 further comprising a second exhaust port in fluid communication with the chamber and configured to exhaust the fluid from the chamber.

13. A bake station comprising:
a bake plate having a thickness defined by a distance between an upper surface and a lower surface of the bake plate, the bake plate being configured to heat a substrate positioned adjacent the upper surface of the bake plate;
a base plate having a first surface positioned below and opposing the lower surface of the bake plate;
a side plate extending between the lower surface of the bake plate and the first surface of the base plate, wherein the side plate, the lower surface of the bake plate, and the first surface of the base plate define a space;
a plurality of nozzles coupled to the base plate, each of the plurality of nozzles having an inlet configured to receive an input flow of fluid and an exit port configured to expel an exit flow of fluid onto the lower surface of the bake plate; and
an exhaust port in fluid communication with the space and configured to exhaust the exit flow of fluid from the space.

14. The bake station of claim 13 further comprising:
a plurality of openings extending through the bake plate; and
a plurality of openings extending through the base plate, wherein each opening in the bake plate is associated with an opening in the base plate.

15. The bake station of claim 14 further comprising:
a first set of collars, each collar extending between an opening in the bake plate and the associated opening in the base plate; and
a plurality of lift pins, each lift pin being configured to extend through a collar to lift the substrate from the upper surface of the bake plate.

16. The bake station of claim 15 wherein each collar forms a seal with the bake plate and the base plate.

17. The bake station of claim 13 wherein the bake plate forms a seal with the side plate.

18. The bake station of claim 13 wherein the bake plate comprises a plurality of heating elements, and wherein the exit flow of fluid from the plurality of nozzles is directed to one or more boundaries between adjacent heating elements.

19. The bake station of claim 13 wherein a rate of the input flow of fluid to each of the plurality of nozzles is controlled independently.

20. The bake station of claim 13 wherein the exhaust port is laterally positioned off-center of the bake plate.

21. The bake station of claim 20 further comprising a second exhaust port in fluid communication with the space and configured to exhaust the fluid from the space.

22. A method of reducing a temperature of a bake plate disposed within a semiconductor processing tool, the method comprising:
establishing a set point temperature;
establishing a predetermined tolerance associated with the set point temperature;
providing a fluid to an inlet of a nozzle in fluid communication with a chamber in thermal communication with the bake plate;
flowing the fluid through one or more exit ports disposed on a surface of the nozzle, wherein the fluid impinges on a backside surface of the bake plate after flowing through the one or more exit ports;
evacuating the fluid through an exhaust port of the chamber;
reducing the temperature of the bake plate from a first temperature greater than the set point temperature to a second temperature;
determining that the temperature of the bake plate is within the predetermined tolerance associated with the set point temperature; and
terminating the flow of the fluid.

23. The method of claim 22 wherein the fluid comprises at least one of nitrogen, helium, air, or clean dry air.

24. The method of claim 22 further comprising providing the fluid to an inlet of another nozzle in fluid communication with the chamber.

25. The method of claim 22 wherein the one or more exit ports comprises a plurality of exit ports disposed on the surface of the nozzle.

26. The method of claim 22 further comprising evacuating the fluid through another exhaust port of the chamber.

27. The method of claim 22 wherein the bake plate forms an upper boundary of the chamber.
